(19) United States
(12) Patent Application Publication
(10) Pub. No.: US 2008/0260911 A1
(43) Pub. Date: Oct. 23, 2008

(54) Method for Manufacturing Coffee Beverage Using Filtered Extract

(76) Inventors: Hitoshi Matsubara, Tokyo (JP); Toshiyuki Tsujimoto, Hyogo (JP); Yoshikiyo Minami, Kanagawa (JP); Kenzo Takahashi, Kanagawa (JP)

Correspondence Address: DRINKER BIDDLE & REATH (DC), 1500 K STREET, N.W., SUITE 1100, WASHINGTON, DC, 20005-1209, US

(21) Appl. No.: 11/792,823

(22) PCT Filed: Dec. 12, 2005
(86) PCT No.: PCT/JP2005/022758

§ 371 Date: May 16, 2008

(30) Foreign Application Priority Data
Dec. 13, 2004 (JP) 2004-360595

(51) Int. Cl. A23F 5/24

(52) U.S. Cl. 426/78; 426/433; 426/475; 426/594; 426/506

(57) ABSTRACT

A method for manufacturing a coffee beverage is provided that is capable of efficiently removing precipitating components and turbid components from a highly concentrated coffee extract 1, and that is also capable of addressing increases in the production volume of the coffee beverage without particularly large changes being made to the scale of the equipment. The coffee extract 1 obtained from an extraction process performed on ground roasted coffee beans is diluted in the method for manufacturing a coffee beverage, and the coffee extract 1 is filtered using a cross-flow filtering apparatus before dilution.

### TECHNICAL FIELD

The present invention relates to a method for manufacturing a coffee beverage involving diluting a coffee extract obtained from an extraction process performed on ground roasted coffee beans.

### BACKGROUND ART

A coffee extract obtained by the so-called “drip extraction method” is used as a primary starting material, and sugar, milk or the like are admixed therewith to yield a commercial coffee beverage. The beverage is then typically filled into cans, plastic bottles made of polyethylene terephthalate (PET), or other packaging containers; and sterilized before being put into circulation.

In order to cut back on the labor (or cost) of shipping or storage, the extracted coffee liquid may be subjected to a vacuum concentration process or otherwise reduced in volume (concentrated). Alternatively, the initial extraction may be performed using a small amount of hot water to obtain a highly concentrated coffee extract.

The highly concentrated coffee extract is diluted to the desired concentration when needed, whereby the coffee beverage is manufactured. However, solids and suspended matter (primarily polysaccharides, lipids, and the like) derived from coffee beans are contained in such by concentrated coffee extracts. The solids and suspended matter therefore aggregate and precipitate out when the highly concentrated coffee extract is diluted and directly used as the product or when the product is stored for short or long periods of time. This has been an extremely serious problem for manufacturers providing beverages.

In the past, steps have therefore generally been carried out involving the decanting, centrifugal separation, or filtration of the pre concentration coffee extract or the diluted coffee extract, whereby the solids, suspended matter, and other components that cause precipitation are removed and the coffee extract is clarified (see, e.g., Patent Document 1).

[Patent Document 1] Japanese Patent No. 2640045

### DISCLOSURE OF THE INVENTION

### Problems that the Invention is Intended to Solve

However, decanting, which requires that the processed liquid be allowed to stand for a prescribed period of time, is time-consuming and inefficient. Processes involving centrifugal separation can bring about precipitation and separation in a short time, but very small turbid components may still remain even if large diameter precipitating components are able to be removed. Such very small turbid components can also be removed by filtration, but since filtration is performed on the pre-concentration or post-dilution coffee extract, which has a relatively low concentration, problems arise in that the volume is large, the process requires time and labor, and extensive changes (size increases) must be made in the scale of the filtration equipment in order to maintain production speed if production volume is to be increased, and the equipment will necessarily be very expensive.

The present invention was devised in light of the aforementioned problems, and provides a method for manufacturing a coffee beverage that is capable of efficiently removing precipitating components and turbid components from a coffee extract, and that is also capable of addressing increases in the production volume of the coffee beverage without particularly large changes being made to the scale of the equipment.

### Means for Solving the Problems

The invention according to a first aspect provides a method for manufacturing a coffee beverage comprising a step for diluting a coffee extract obtained from an extraction process performed on ground roasted coffee beans, the method for manufacturing a coffee beverage comprising a step for filtering the coffee extract using a cross-flow filtering apparatus before dilution.

According to a second aspect of the present invention, the cross-flow filtering apparatus is a vibrating cross-flow filtering apparatus.

According to a third aspect of the present invention, a temperature of the coffee extract during filtration is 40° C. to 80° C.

According to a fourth aspect of the present invention, the coffee extract has been concentrated.

According to a fifth aspect of the present invention, the extraction process is performed using a gas-liquid countercurrent contact extraction method.

The invention according to a sixth aspect comprises a step for adding a flavor component obtained by the gas-liquid countercurrent contact extraction method.

The invention according to a seventh aspect provides a method for manufacturing a highly clarified coffee extract comprising a step for obtaining the coffee extract from an extraction process performed on ground roasted coffee beans, the method for manufacturing a highly clarified coffee extract flier comprising a step for filtering the coffee extract using a cross-flow filtering apparatus.

According to an eighth aspect of the present invention, the cross-flow filtering apparatus is a vibrating cross-flow filtering apparatus.

According to a ninth aspect of the present invention, a temperature of the coffee extract during filtration is 40° C. to 80° C.

According to a tenth aspect of the present invention, the coffee extract has been concentrated.

According to an eleventh aspect of the present invention, the e on process is performed using a gas-liquid countercurrent contact extraction method.

The invention according to a twelfth aspect provides a highly clarified coffee extract obtained by the method for manufacturing a highly clarified coffee extract according to any of the aforedescribed seventh through eleventh aspects.

The invention according to a tenth aspect provides a method for manufacturing a coffee beverage, comprising a step for diluting the highly clarified coffee extract according to the twelfth aspect.

The invention according to a fourteenth aspect provides a container-packed coffee beverage manufactured by the method for manufacturing a coffee beverage according to any of the first through sixth or thirteenth aspects.

### EFFECT OF THE INVENTION

In the method for manufacturing a coffee beverage according to the first aspect of the present invention, a coffee beverage is manufactured after completing a step for diluting a coffee extract obtained from an extraction process performed on ground roasted coffee beans. The coffee extract that is obtained is small in volume compared to the coffee beverage, is extremely convenient for shipping or storage, and allows cutbacks in production costs to be achieved. The coffee extract can be diluted to the desired concentration when necessary, and therefore coffee beverages of a variety of concentrations can also be manufactured to suit consumer preferences.

The characteristics of the present invention include the step for filtering the coffee extract using a cross-flow filtering apparatus before dilution. Minute turbid particles, which are difficult to isolate using centrifugal separation methods, and precipitating components contained in the coffee extract can therefore be efficiently separated and removed. A structural characteristic of cross-flow filtering apparatuses is their resistance to clogging, and these filtering apparatuses can therefore operate continuously even with hilly concentrated coffee extracts (having a Brix value of, e.g., 15 to 50). Therefore, in comparison to conventional methods in which a pre-concentration or post-dilution coffee extract is filtered, continuous operation is possible, and processing speed can be rapidly improved to the extent of the reduction in volume of the processed solution. This method is thus able to be employed without the scale of the equipment needing to undergo extensive change, even when the production volume of the coffee beverage is increased.

According to the method for manufacturing a coffee beverage according to the second aspect of the present invention, the filtering parts of the vibrating cross-flow filtering apparatus vibrate and have high shear force, and the filtering apparatus can ensure a high filtration flow volume using a small filtration surface area. Liquids that are difficult to filter can therefore be processed, and the size of the filtering apparatus can be reduced relative to standard cross-flow filtering apparatuses.

According to the method for manufacturing a coffee beverage according to the third aspect of the present invention, filtration is performed on the coffee extract at a temperature of 40° C. to 80° C. The coffee extract is therefore not degraded, and the fluidity of even highly concentrated coffee extracts (having a Brix value of, e.g., 15 to 50) can be maintained (or increased). Filtration can therefore be implemented quickly and efficiently.

According to the method for manufacturing a coffee beverage according to the fourth aspect of the present invention, the coffee extract has been concentrated. The volume of the coffee extract is therefore small, the convenience of shipping or storage can be improved, and the shipping management costs can be reduced. If a coffee extract made in large volumes in order for the largest possible amount of coffee components to be extracted from the coffee beans is used after being concentrated, the cost of raw materials can be reduced, and a coffee that has a richer flavor due to the higher quantities of coffee components contained therein can be manufactured.

According to the method for manufacturing a coffee beverage according to the fifth aspect of the present invention, the extraction process is performed using a gas-liquid countercurrent contact extraction method, and therefore coffee flavor components can also be efficiently procured along with the coffee extract. In other words, the raw materials of the coffee are used more effectively, and therefore the cost of the raw materials can be reduced relative to methods for manufacturing a coffee beverage by mixing the coffee extract and the coffee flavor components after the coffee extract and the coffee flavor components have been procured from separate raw materials.

According to the method for manufacturing a coffee beverage according to the sixth aspect of the present invention, a flavor component obtained by the gas-liquid countercurrent contact extraction method is added, whereby a variety of coffee beverages having rich flavor that suits consumer preferences can be manufactured.

According to the method for manufacturing a highly clarified coffee extract according to the seventh aspect of the present invention, a step is included for using a cross-flow filtering apparatus to filter a coffee extract obtained from an extraction process performed on ground roasted coffee beans, and therefore a highly clarified coffee extract can be manufactured in which minute turbid particles, which are difficult to isolate using cents separation methods, and precipitating components contained in the coffee extract are efficiently separated and removed.

A structural characteristic of cross-flow filtering apparatuses is their resistance to clogging, and these filtering apparatuses can therefore operate continuously even with highly concentrated coffee extracts (having a Brix value of, e.g., 15 to 50). Since a concentrated coffee extract that has been reduced in volume is processed, highly-clarified coffee extracts can be manufactured quickly and simply (efficiently). This method is thus able to be employed without the scale of the equipment needing to undergo extensive change, even when the production volume of the highly clarified coffee extract is increased. The resulting highly concentrated and clarified coffee extract is diluted to the desired concentration as needed, whereby large volumes of a coffee beverage from which precipitating components and turbid components have been removed can be manufactured at a low cost.

According to the method for manufacturing a highly clarified coffee extract according to the eighth aspect of the present invention, the filtering parts of the vibrating cross-flow filtering apparatus vibrate and have high shear force, and the filtering apparatus can ensure a high filtration flow volume using a small filtration surface area. Liquids that are difficult to filter can therefore be processed, and the size of the filtering apparatus can be reduced relative to standard cross-flow filtering apparatuses.

According to the method for manufacturing a highly clarified coffee extract according to the ninth aspect of the present invention, filtration is performed on the coffee extract at a temperature of 40° C. to 80° C. The coffee extract is therefore not degraded, and the fluidity of even highly concentrated coffee extracts (having a Brix value of, e.g., 15 to 50) can be maintained (or increased). Filtration can therefore be implemented quickly and efficiently.

According to the method for manufacturing a highly clarified coffee extract according to the tenth aspect of the present invention, the coffee extract has been concentrated. The volume of the coffee extract is therefore small, the convenience of shipping or storage can be improved, and shipping management costs can be reduced. If a coffee extract made in large volumes in order for the largest possible amount of coffee components to be extracted from the coffee beans is used after being concentrated, the cost of raw materials can be reduced, and a highly clarified coffee extract containing increased amounts of coffee components can be manufactured.

According to the method for manufacturing a highly clarified coffee extract according to the eleventh aspect of the present invention, the extraction process is performed using a gas-liquid countercurrent contact extraction method, and therefore coffee flavor components can also be efficiently procured along with the coffee extract.

A highly clarified coffee extract according to the twelfth aspect of the present invention is obtained by the method for manufacturing a highly clarified coffee extract according to any of the aforedescribed seventh through eleventh aspects. Minute turbid particles, which are difficult to isolate using centrifugal separation methods, and precipitating components contained in the coffee extract are separated and removed. A coffee beverage in which precipitation does not readily occur during storage can therefore be manufactured if the highly clarified coffee extract of the present invention is used.

According to the method for manufacturing a coffee beverage according to the thirteenth aspect of the present invention, the highly clarified coffee extract according to the aforedescribed twelfth aspect is diluted, and the concentration can be appropriately adjusted to suit the preferences of the consumer. A coffee beverage in which precipitation does not readily occur during storage can therefore be manufactured to suit the preferences of the consumer.

The container-packed coffee beverage according to the fourteenth aspect of the present invention can be manufactured by any of the methods for manufacturing a coffee beverage according to the aforedescribed first through sixth or thirteenth aspects and has a strong coffee flavor and a clear taste.

### BEST MODE FOR CARRYING OUT THE INVENTION

Embodiments of the present invention will be described below on the basis of the drawings.

Roasted, ground coffee beans are put into a coffee-extracting apparatus and coffee components are extracted according to standard methods, as shown in FIG. 1. The coffee-extracting apparatus used in the present embodiment is a gas-liquid countercurrent contact extraction apparatus, preferably an SCC (spinning cone column) extraction apparatus as described in Japanese Examined Patent Application No. 7-22646. Separated flavor components and coffee extract can be efficiently procured from the same raw material (roasted coffee beans) using an SCC extraction apparatus.

The conditions below may be used as an example of conditions under which an extract can be efficiently obtained using an SCC extraction apparatus, but any setting may be used as long as a coffee extract for a coffee beverage is obtained.

(1) Method for grinding the beans: The raw coffee beans are preferably mixed with water and ground at the same time (subjected to wet grinding) and then put into the SCC extraction apparatus rather than being ground individually (subjected to dry grinding) and then mixed with water and put into the apparatus.

(2) Grain size of ground beans: Grinding is preferably performed so that the peal: particle diameter is approximately 1 mm.

(3) Mixing ratio of coffee beans and water: The amount of soluble solids (the Brix value) of the coffee extract increases as the mixing ratio of the coffee beans increases, but the amount of soluble solids per unit weight of the extract decreases. A coffee bean/water ratio of approximately 9:1 (weight ratio) is therefore preferable.

(4) Temperature when supplying the raw material: 80 to 90° C. is preferable.

(5) Temperature during SCC extraction: 80° C. to 100° C. is preferable.

(6) Cone rotational frequency: Extraction efficiency is low when the cone rotational frequency is equal to or less than a set value. Approximately 500 to 600 rpm is therefore preferable.

Minute coffee bean particles and a variety of other excess solids remaining in the coffee extract obtained using an SCC extraction apparatus under the conditions for highly efficient extraction described above are then decanted, separated by centrifugation, or otherwise removed (preliminary removal of solids).

After preliminary removal of general solids, the coffee extract is concentrated using an appropriate concentrating apparatus. The method of concentration is not particularly limited, but the principles of the thin-film vacuum concentration method can generally be appropriately employed. The concentration of soluble solids in the coffee liquid after concentration is also not limited, but taking into account the capabilities of the concentrating apparatus and other factors, concentration is preferably performed to a Brix value in the range of 15 to 50. The Brix value is the value read from a Brix hydrometer or a refractometer (limited to instruments that grade the index of region as the percent content of sucrose (the Brix value)) at 20° C. (when measurement is performed at a temperature other than 20° C., the value is corrected to the value at 20° C.)

The concentrated coffee extract is then clarified using the cross-flow filtration method. Centrifugal separation or pressure filtration is usually used when clarifying highly concentrated coffee extracts. However, solids are frequently deposited when a supernatant or filtrate clarified using these general operations is, e.g., diluted to the concentration of a normal coffee beverage (a Brix value of approximately 1 to 10).

However, the occurrence of such post-dilution deposits can be prevented or reduced if the aforementioned cross-flow filtration method is used. In other words, the coffee extracts that are the primary object of the cross-flow filtration method are coffee extracts from which solids will be inadequately separated by standard cent gal separation and the like. The term “coffee extract” in the present invention includes extracts that have been concentrated, diluted, regulated in pH, subjected to enzymatic treatments, heated, or cooled, e.g., coffee extracts obtained by concentrating the coffee extracts obtained by standard extraction operations, or coffee extracts obtained using extraction methods in which a highly concentrated coffee extract is obtained (e.g., extractions using an initially small volume of hot water). To be more specific, a coffee extract in which the amount of dilution precipitation is 1.0% or more in the supernatant after a standard centrifugal separation operation (6500 rpm for 5 minutes) can be suitably used. The amount of dilution precipitation is indicative of the amount of solid that will be generated during dilution. Specifically, the amount of dilution precipitation refer to the wet weight (weight %) of the precipitants newly generated when diluting to a Brix value of 1.0, and recovered by a centrifugal separation operation (6500 rpm for 5 minutes).

Examples of coffee extracts having a large amount of dilution precipitation are those obtained by the aforedescribed gas-liquid countercurrent contact extraction method (e.g., the SCC extraction method) and the concentrated liquid of this coffee extract. Above all, the aforementioned cross-flow filtration method can be suitably used when the operating conditions of the SCC ex on apparatus are set with the aim of improving the extraction efficiency, and a coffee extract having a higher concentration or a concentrated solution of this extract is obtained. Increases and decreases in extraction efficiency can be determined using the value for soluble solids (the Brix value) in the extract.

The principles of cross-flow filtering apparatuses are already well-known, and a large number of apparatuses are in the marketplace. The model and operating principle of the cross-flow filtering apparatus are not limited, with a suitable example being a vibrating cross-flow filtering apparatus having a high filtration speed and a small size (FIG. 2).

Vibrating cross-flow filtering apparatuses have filtering parts 3 that vibrate, thereby exhibiting a high shear force on materials that have a larger diameter than the filter holes (e.g., excess solids 2 in a concentrated coffee extract 1 that was concentrated according to the present embodiment) and that have the potential to adhere to the filtering parts 3 and clog the holes therein. The holes in the filtering medium are kept from clogging, and a highly clarified coffee extract 4 is obtained. These filtering apparatuses can maintain high filtration flow volume using a small filtration surface area. The model and operating principle of the vibrating cross-flow filtering apparatus are not particularly limited so long as the cleanness and safety are such that the filtering apparatus is guaranteed not to result in problems when used for the manufacture of food products. For example, the “Pallsep™” of Nihon Pall, Ltd. or the “V-SEP™” of New Logic Research, Inc. may be appropriately used.

There are no particular imitations in regard to the filtering medium installed in the cross-flow filtering apparatus, but a wide variety of materials can be used, provided that the degree of safety of the material is adequate to prevent the manufacture of food products from being compromised. For example, ceramic filtering media can be suitably used in standard cross-flow filtering apparatuses. Polyethylene terephthalate, which is a material that resembles Teflon (registered trademark), and the like can be suitably used in vibrating cross-flow filtering apparatuses.

Pressure loss during filtration will increase as the pore diameter of the filtering medium decreases. As a result, filtration performance decreases, and clogging of the film will occur more quickly. Conversely, depending on the nature of the coffee liquid, clogging may also be facilitated if the pore diameter of the filtering medium is too large. The pore diameter of the filtering medium must therefore be selected appropriately according to the nature of the coffee extract and the desired filtration performance. The pore diameter in the present invention is not particularly limited as long as the diameter is within a range in which the precipitating components and turbid components contained in the coffee extract can be efficiently removed. The pore diameter can be freely selected according to desired processing speed and the concentration of soluble solids in the extract. The pore diameter is preferably, e.g., 0.1 to 3.0 μm, with 0.45 μm being especially preferable.

In order to prevent clogging, a variety of techniques, e.g., removing solids or adding water to the liquid to be filtered, may also be concurrently employed.

The temperature of the filtrate during operation is not particularly limited, but filtration is preferably performed at as high a temperature as possible in order to ensure filtration performance (fluidity and the like). However, an excessively high temperature will facilitate reductions in the quality of the coffee in the present invention. Accordingly, a range in which the filtration efficiency is not significantly reduced and in which degradation of the coffee extract will not be facilitated is preferable. A range of, e.g., 40° C. to 80° C. is preferable, with 45° C. to 60° C. being especially preferable.

Flavor components obtained by the aforedescribed SCC extraction apparatus, water, coffee extract of normal concentration obtained using standard methods, sugar, milk components, and the like are appropriately added and mixed as necessary as principal raw materials with the clear, highly concentrated coffee extract (highly clarified coffee extract) obtained using such means and measures. After packaging and sterilization, a container-packed coffee beverage can thereby be manufactured without the formation of solid deposits during steps for diluting the coffee extract. The composition ratio of the amount of highly clarified coffee extract to the total amount of coffee raw materials (expressed as solids) used in the product is not limited and may be set to any value between 1% and 100%. Cans, glass bottles, plastic (PET) bottles, and the like may be selected as the container. A container-packed coffee beverage can thereby be manufactured having a strong coffee flavor and a clear taste in which no recognizable precipitation will occur due to long-term storage.

### EXAMPLE 1

50 kg of roasted coffee beans were ground along with 450 kg of water in a wet grinder. This mixture was subjected to extraction in an SCC extraction apparatus (Flavourtech M1,000) at 100° C. and a supply flow rate of 350 L/hr. As a result, a coffee extract having a Brix value of 3.4 was obtained. The resulting coffee extract was processed using a centrifugal separator in order to remove excess solids and then concentrated to a Brix value of 29.9 in a thin-film vacuum-type concentrator to obtain a concentrated coffee liquid.

100 g of the concentrated coffee liquid was diluted to a Brix value of 1.0 using pure water, and precipitation was forcibly initiated in order to measure the precipitating components contained in the concentrated coffee liquid. After centrifugal separation at 6300 rpm for 5 minutes, the supernatant was removed. The result of measuring the weight of the remnants was 17.4 g (wet weight), which is an extremely high value. This concentrated coffee liquid was subjected to four types of methods for removing precipitants.

Invention 1: The concentrated coffee liquid was subjected to cross-flow filtration using a ceramic filter (Noritake Co. Ltd., product name: MEMBRALOX; type: Φ4×1020×0.1; pore diameter. 0.2 μm; filtration surface area: 0.24 m², filtration flow rate: 2.7 L/hr; filtration temperature 40° C.), and a filtered concentrated coffee liquid (highly clarified coffee extract) was obtained.

Invention 2: The concentrated coffee liquid was supplied to a vibrating cross-flow filtering apparatus (Nihon Pall, Ltd., product name: Pallsep; model: PS-10; film pore diameter: 0.45 μm; film surface area: 0.9 m², filtration flow rate: 13.3 L/m²/hr; filtration temperature 50° C.), which is a type of cross-flow filter, and a filtered concentrated coffee liquid (highly clarified coffee extract) was obtained.

Comparative article 1: The concentrated coffee liquid was supplied to a centrifugal separator (Alfa Laval K.K., product name: LAPX202; centrifugal sedimentation surface area: 1060 m²; rotational speed: 10,000 rpm; supply flow rate: 5 L/hr), and a centrifugally separated concentrated coffee liquid was obtained.

Comparative article 2: The concentrated coffee liquid was supplied to a depth filter. (Cuno Inc., product name: Cuno 10S), which is a type of pressurized filter.

Brix values and amounts of dilution precipitation were measured for the resulting samples. The amounts of dilution precipitation were obtained by measuring the wet weight (%) of solids after performing centrifugal separation for 5 minutes at 6300 rpm on diluted solutions resulting from diluting the samples with water to a Brix value of 6.0. The results are shown in Table 1.

TABLE 1

| | | | Amount of dilution | | |
|---|---|---|---|---|---|
| | Brix value | | precipitation | | |
| | Before | After | Before | After | |
| | processing | processing | processing | processing | Taste |
| Invention 1 | 29.9 | 29.6 | 17.4% | 0.0% | Clear, |
| | | | | | good |
| Invention 2 | 29.9 | 28.0 | 17.4% | 0.0% | Clear, |
| | | | | | good |
| Comparative | 29.9 | 29.7 | 17.4% | 2.5% | Some |
| article 1 | | | | | unex- |
| | | | | | pected |
| | | | | | flavor |
| Comparative | 29.9 | — | 17.4% | — | — |
| article 2 | | | | | |

The amount of dilution precipitation in Invention 1 and Invention 2 was 0%, which is thought to be a result of the extremely efficient removal of precipitants or materials that cause precipitation by the cross-flow filtering apparatus. The method of filtration of the present invention thus displays the ability to minimize the occurrence of precipitation during dilution.

Meanwhile, the amount of dilution precipitation in Comparative article 1 was 2.5%. This measure was also effective to a certain extent as a method for removing precipitating components in comparison to the amount of precipitation in the concentrated liquid before the centrifugal separation operation, but the effect of reducing the amount of dilution precipitation was Inadequate in comparison with Inventions 1 and 2.

Meanwhile, the filtration step itself was difficult in Comparative article 2, with clogging and other problems soon resulting, and filtration was not possible.

A sensory evaluation was also performed on these samples (Table 1). The concentrated coffee liquids obtained in Inventions 1 and 2 displayed a clear taste. Comparative article 1 was judged to have a slight heaviness and roughness in taste, which is consistent with the detection of a small amount of precipitation.

### EXAMPLE 2

Canned milk coffee bevels were prepared using the three aforedescribed samples (Invention 1, Invention 2, and Comparative article 1). The composition ratio of the amount of concentrated coffee liquid to the total amount of coffee raw materials (expressed as solids) was 30%. Extracts from a standard drip method were used for the other coffee raw materials. Sugar, milk, and the like were added in equal amounts to each extract; the cans were sealed; and caned milk coffee beverages were prepared and named Invention 3, Invention 4, and Comparative article 3, respectively. The coffee beverages were subjected to a storage test (55° C. for 1 month), and the state of precipitation was visually observed. None of the beverages had any precipitation when storage began. The results are shown in Table 2.

TABLE 2

| | Precipitation after storage test |
|---|---|
| Invention 3 | − |
| Invention 4 | − |
| Comparative article 3 | + |

(−: none; +: present)

(−: none; +: present)

Precipitation did not occur in Invention 3 and Invention 4 after storage, as shown in Table 2. However, precipitation occurred in Comparative article 3 after storage. Effective suppression of precipitation after storage is therefore displayed by the beverage of the present invention. Invention 3 and Invention 4 also had a strong coffee flavor and a clear taste without any unexpected flavor when taste-tested after storage.

### EXAMPLE 3

50 kg of roasted coffee beans (a mixture of Brazilian, Colombian, and Guatemalan beans) were mixed with water in a 1:9 ratio and ground to a particle diameter of approximately 1 mm. This liquid was fractionated into volatile components and extract liquid using a Flavourtech SCC (Spining Corn Column) M1,000, which is a type of gas-liquid countercurrent contact extraction apparatus, operating under the conditions below.

Raw-material supply rate: 350 L/hr

Vapor flow volume: 17.5 kg/hr

Amount of vaporization: 17.5 kg/hr

Temperature at bottom of column: 100° C.

Temperature at top of column: 100° C.

Extent of vacuum: Atmospheric pressure

The volatile components were recovered with the water vapor. The resulting volatile components were immediately cooled to 20° C. or less, and 25 liters of an aqueous solution (Brix value 0.2) containing flavor components was obtained. A Brix value of 3.4 was measured for the extract liquid. This coffee extract was processed using a centrifugal separator in order to remove excess solids and then concentrated to a Brix value of 29.9 in a thin-film vacuum concentrator to obtain a concentrated coffee liquid.

The concentrated coffee liquid was supplied to a vibrating cross-flow filtering apparatus (Nihon Pall, Ltd., product name: Pallsep; model: PS-10; film pore diameter: 0.45 μm; film surface area: 0.9 m², filtration flow rate: 13.3 L/m²/hr; filtration temperature 50° C.), which is a type of cross-flow filter, and a filtered concentrated coffee liquid (highly clarified coffee extract) was obtained. Dilution with water was performed in order to further adjust the concentration, and a highly clarified coffee extract having Brix value of 20 was obtained. Precipitation did not occur during this dilution operation.

A coffee beverage was prepared using the highly clarified coffee extract and the aqueous solution containing flavor components thus obtained as the raw materials. First, a coffee extract having a normal concentration was obtained separately according to standard methods. Specifically, 410 kg of ground material resulting from the middle-grinding of roasted coffee beans (a mixture of Brazilian, Colombian, and Guatemalan beans) was subjected to extraction in water at 95° C., and approximately 3000 L of coffee extract (coffee extract having a Brix value of 3.5, i.e., a normal concentration) was obtained.

480 kg of the aforedescribed highly clarified coffee extract was admixed with six times that amount of coffee extract (the coffee extract having a normal concentration). Precipitation did not occur during this mixing/dilution operation. Cream, sugar, emulsifiers, and sodium bicarbonate were added in appropriate amounts, and approximately 2.5% by mass of the aforedescribed aqueous solution containing flavor components was added. After mixing, the temperature was raised to 70° C., and homogenization was performed at 20 MPa using a homogenizer. The resulting liquid was filled into cans having a capacity of 190 g, sterilization was performed at 125° C. for 20 minutes, and coffee beverages were prepared. The resulting coffee beverages included 2% soluble solids derived from coffee.

A sensory evaluation was performed on the present coffee beverages. The coffee flavor was strong and clear, without any unexpected flavor. Stable preservation of quality in which precipitants are not formed during retort sterilization or long term storage was able to be verified for the present product.

### INDUSTRIAL APPLICABILITY

The present invention is particularly useful in the industrial manufacture of coffee beverages and is capable of contributing to further developments in such industries.

### BRIEF DESCRIPTION OF THE DRAWINGS

FIG. 1 is a flow chart that shows the sequence of the method for manufacturing a coffee beverage according to the present invention; and

FIG. 2 is a conceptual drawing of vibrating cross-flow filtration.

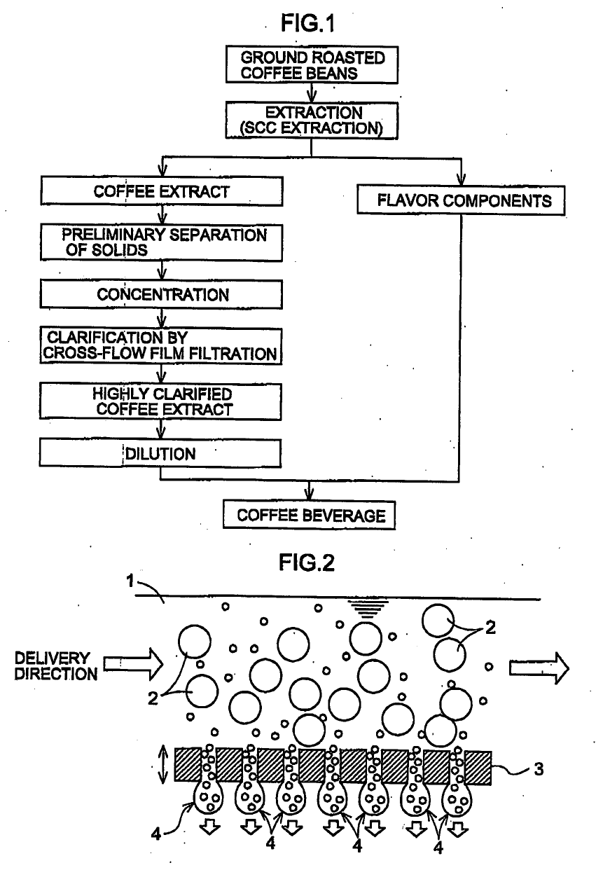

### KEY

1 Concentrated coffee extract
2 Excess solid
3 Filtering part
4 Highly clarified coffee extract

1. A method for manufacturing a coffee beverage comprising a step for diluting a coffee extract obtained from an extraction process performed on ground roasted coffee beans, the method for manufacturing a coffee beverage comprising:
a step for filtering the coffee extract using a cross-flow filtering apparatus before dilution.

2. The method for manufacturing a coffee beverage according to claim 1, wherein the cross-flow filtering apparatus is a vibrating cross-flow filtering apparatus.

3. The method for manufacturing a coffee beverage according to claim 1, wherein a temperature of the coffee extract during filtration is 40° C. to 80° C.

4. The method for manufacturing a coffee beverage according to claim 1, wherein the coffee extract has been concentrated.

5. The method for manufacturing a coffee beverage according to claim 1, wherein the extraction process is performed using a gas-liquid countercurrent contact extraction method.

6. The method for manufacturing a coffee beverage according to claim 5, comprising a step for adding a flavor component obtained by the gas-liquid countercurrent contact extraction method.

7. A method for manufacturing a highly clarified coffee extract comprising a step for obtaining a coffee extract from an extraction process performed on ground roasted coffee beans, the method for manufacturing a highly clarified coffee extract further comprising:
a step for filtering the coffee extract using a cross-flow filtering apparatus.

8. The method for manufacturing a highly clarified coffee extract according to claim 7, wherein the cross-flow filtering apparatus is a vibrating cross-flow filtering apparatus.

9. The method for manufacturing a highly clarified coffee extract according to claim 7, wherein a temperature of the coffee extract during filtration is 40° C. to 80° C.

10. The method for manufacturing a highly clarified coffee extract according to claim 7, wherein the coffee extract has been concentrated.

11. The method for manufacturing a highly clarified coffee extract according to claim 7, wherein the extraction process is performed using a gas-liquid countercurrent contact extraction method.

12. A highly clarified coffee extract, obtained by the method for manufacturing a highly clarified coffee extract according to claim 7.

13. A method for manufacturing a coffee beverage, comprising a step for diluting the highly clarified coffee extract according to claim 12.

14. A container-packed coffee beverage manufactured by the method for manufacturing a coffee beverage according to claim 1.

15. A container-packed coffee beverage manufactured by the method for manufacturing a coffee beverage according to claim 13.
